(19) United States
(12) Patent Application Publication
(10) Pub. No.: US 2026/0287368 A1
(43) Pub. Date: Sep. 24, 2026

(54) SYSTEM AND METHOD FOR ESTIMATING ODOMETRY USING LIDAR AND ARTIFICIAL INTELLIGENCE

(71) Applicants: Hyundai Motor Company, Seoul (KR); Kia Corporation, Seoul (KR)

(72) Inventors: Eun Ji CHO, Hwaseong-Si (KR); Dong Wook SHU, Hwaseong-Si (KR)

(21) Appl. No.: 19/337,041

(22) Filed: Sep. 23, 2025

(30) Foreign Application Priority Data
Mar. 19, 2025 (KR) 10-2025-0035510

(51) Int. Cl. G01C 21/30; B60W 60/00

(52) U.S. Cl. CPC G01C 21/30; B60W 60/001; B60W 2420/408; B60W 2530/18; B60W 2556/40; B60W 2556/50

(57) ABSTRACT

An apparatus of a vehicle may comprise a processor and a memory storing at least one instruction that, when executed by the processor communicating with the memory, is configured to cause the apparatus to obtain, from a sensor of the vehicle, point cloud data associated with at least one object in a surrounding environment of the vehicle, extract, based on an artificial intelligence model of the vehicle, a surface and edge feature for each frame of the point cloud data, update 6 degrees of freedom (6-DOF) odometry-related information of the vehicle, update a map of the surrounding environment of the vehicle, output a signal indicating the updated map, and control, based on the signal, autonomous driving of the vehicle.

### CROSS-REFERENCE TO RELATED APPLICATION

This application claims the benefit of priority to Korean Patent Application No. 10-2025-0035510, filed in the Korean Intellectual Property Office on Mar. 19, 2025, the entire contents of which are incorporated herein by reference.

### TECHNICAL FIELD

The present disclosure relates to a system and a method for estimating odometry using light and detection ranging (LiDAR) and artificial intelligence (AI), and more particularly, relates to an AI system for estimating odometry with high reliability based on a LiDAR sensor even in an environment in which it is difficult to transmit and receive a wireless signal for positioning, such as an indoor parking lot, and a method thereof.

### BACKGROUND

The matters described in this Background section are only for enhancement of understanding of the background of the disclosure, and should not be taken as acknowledgment that they correspond to prior art already known to those skilled in the art.

Various sensors and an artificial intelligence (AI) technology may be used to support an autonomous driving function of the vehicle. For example, which object is present in front of a vehicle which is driving, how far the distance between the object and the vehicle is, or on which algorithm the vehicle should respond according to each specific situation to ensure safety are considered.

High-performance sensors, (e.g., light detection and ranging (LiDAR) for recognizing a surrounding environment using laser beams, radio detection and ranging (RADAR) using radio waves, an ultrasonic sensor, a fisheye camera capable of capturing a 360-degree image, a multifocal lens, and a global positioning system (GPS)) may be loaded into the vehicle.

It is possible to aggregate the measured results obtained from the plurality of sensors to implement a super sensor vehicle. The concept of a super sensor in self-driving or autonomous driving refers to a technology for combining measured values of various sensors to more accurately recognize a surrounding environment, rather than relying on an individual sensor, for convenience or safety of vehicle driving. As information and communications technology (ICT) and cloud technology are added to this, a sensor necessary for autonomous driving and an AI algorithm associated with it are becoming more advanced than ever, for example, may remotely accumulate data in units of a fleet of vehicles, rather than targeting only one vehicle, and may train an AI server and a database to increase the reliability of determination of the vehicle sensor.

However, although it is very important to identify whether an ego-vehicle is currently in any position in coordinates in space to implement autonomous driving, a situation in which it is difficult to perform positioning using a wireless signal of a global positioning system (GPS) sensor or the like, such as an underground parking lot, may frequently occur. In other words, even an autonomous vehicle may completely depend on an autonomous driving sensor, such as LiDAR or a camera sensor, sometimes to perform positioning via complex operations. In this case, the reliability of positioning may not be very high.

To overcome the above problem, various approaches for combining an image processing technology using a LiDAR sensor and an AI technology are considered to increase positioning performance even in an environment where it is difficult to receive a wireless signal (e.g., underground parking lots, tunnels, or warehouses, etc.).

### SUMMARY

The present disclosure has been made to solve the above-mentioned problems occurring.

An example of the present disclosure provides a system and a method for estimating odometry using light and detection ranging (LiDAR) and artificial intelligence (AI), and more particularly, provides an AI system for estimating odometry with high reliability based on a LiDAR sensor even in an environment in which it is difficult to transmit and receive a wireless signal for positioning, such as an indoor parking lot, and a method thereof.

The technical problems to be solved by the present disclosure are not limited to the aforementioned problems, and any other technical problems not mentioned herein will be clearly understood from the following description by those skilled in the art to which the present disclosure pertains.

The present disclosure may be implemented in the following various examples to address all or at least some of the above-mentioned technical problems.

According to the present disclosure, an apparatus of a vehicle, the apparatus may comprise a processor, and a memory storing at least one instruction that, when executed by the processor communicating with the memory, is configured to cause the apparatus to obtain, from a sensor of the vehicle, point cloud data associated with at least one object in a surrounding environment of the vehicle, extract, based on an artificial intelligence model of the vehicle, a surface and edge feature for each frame of the point cloud data, based on the extracted surface and edge feature, update 6 degrees of freedom (6-DOF) odometry-related information of the vehicle, based on the updated 6-DOF odometry-related information, update a map of the surrounding environment of the vehicle, output a signal indicating the updated map, and control, based on the signal, autonomous driving of the vehicle.

The apparatus, wherein the at least one instruction that, when executed by the processor communicating with the memory, is configured to cause the apparatus to extract the surface and edge feature by calculating point curvature for each range view (RV) image layer for the point cloud data, dividing, as an RV image layer, a portion of the point cloud data that has no occlusion effect into sub-regions, sorting the sub-regions in descending order of the calculated point curvature, determining, for each of the sub-regions, whether object class classification information from the point cloud data indicates that the sub-region should be excluded from the surface and edge feature extraction, and based on the sub-region not being excluded, determining whether the sub-region satisfies an edge line condition, wherein the edge line condition corresponds to a condition indicating a presence of a linear edge.

The apparatus, wherein the determining of whether the sub-region satisfies the edge line condition may comprise selecting a plurality of nearest neighbor points from among a plurality of points within the sub-region, determining, based on the plurality of selected nearest neighbor points, a covariance matrix, determining whether an eigen value condition associated with the covariance matrix is satisfied to indicate a straight line object, and determining whether a cosine similarity condition associated with the covariance matrix is satisfied to indicate an object with a vertical component.

The apparatus, wherein the plurality of nearest neighbor points are selected, using a tree data structure, based on an L2 norm distance between points within the point cloud data.

The apparatus, wherein the at least one instruction that, when executed by the processor communicating with the memory, is configured to cause the apparatus to update the 6-DOF odometry-related information of the vehicle by performing, based on the extracted surface and edge feature, point-to-line fitting and point-to-plane fitting to determine a spatial transformation for updating the 6-DOF odometry-related information of the vehicle.

The apparatus, wherein the at least one instruction that, when executed by the processor communicating with the memory, is configured to cause the apparatus to update the 6-DOF odometry-related information of the vehicle by based on results of the point-to-line fitting and point-to-plane fitting, performing a nonlinear process to determine the spatial transformation.

The apparatus, wherein the performing of the point-to-line fitting and point-to-plane fitting may comprise selecting a plurality of nearest neighbor points from among points within the point cloud data using a tree data structure, and based on the selected plurality of nearest neighbor points, determining a covariance matrix and performing a QR decomposition process.

The apparatus, wherein the performing of the point-to-line fitting and point-to-plane fitting may comprise searching for a correspondence line or plane among points accumulated in the map of the surrounding environment of the vehicle.

The apparatus, wherein an initial value of the nonlinear process is set based on previous odometry information.

The apparatus, wherein the at least one instruction that, when executed by the processor communicating with the memory, is configured to cause the apparatus to update the map of the surrounding environment of the vehicle by determining, based on the updated 6-DOF odometry-related information, coordinates in space for the vehicle, extracting, from the map of the surrounding environment, based on a hyperparameter assigned to each axis of the coordinates in space, data accumulated for updating the map of the surrounding environment, applying the updated 6-DOF odometry-related information to a current frame of the point cloud data, and performing voxel downsampling based on voxel grid filtering for the current frame of the point cloud data to which the updated 6-DOF odometry-related information is applied, and accumulating resulting points of the voxel downsampling for updating the map of the surrounding environment.

According to the present disclosure, a method performed by an apparatus of a vehicle, the method may comprise obtaining, from a sensor of the vehicle, point cloud data associated with at least one object in a surrounding environment of the vehicle, extracting, based on an artificial intelligence model of the vehicle, a surface and edge feature for each frame of the point cloud data, based on the extracted surface and edge feature, updating 6 degrees of freedom (6-DOF) odometry-related information of the vehicle, based on the updated 6-DOF odometry-related information, updating a map of the surrounding environment of the vehicle, outputting a signal indicating the updated map, and controlling, based on the signal, autonomous driving of the vehicle.

The method, wherein the extracting of the surface and edge feature may comprise calculating point curvature for each range view (RV) image layer for the point cloud data, dividing, an RV image layer, a portion of the point cloud data that has no occlusion effect into sub-regions, sorting the sub-regions in descending order of the calculated point curvature, determining, for each of the sub-regions, whether object class classification information from the point cloud data indicates that the sub-region should be excluded from the surface and edge feature extraction, and based on the sub-region not being excluded, determining whether the sub-region satisfies an edge line condition, wherein the edge line condition corresponds to a condition indicating a presence of a linear edge.

The method, wherein the determining of whether the sub-region satisfies the edge line condition may comprise selecting a plurality of nearest neighbor points from among a plurality of points within the sub-region, determining, based on the plurality of selected nearest neighbor points, a covariance matrix, determining whether an eigen value condition associated with the covariance matrix is satisfied to indicate a straight line object, and determining whether a cosine similarity condition associated with the covariance matrix is satisfied to indicate an object with a vertical component.

The method, wherein the plurality of nearest neighbor points are selected, using a tree data structure, based on an L2 norm distance between points within the point cloud data.

The method, wherein the updating of the 6-DOF odometry-related information may comprise performing, based on the extracted surface and edge feature, point-to-line fitting and point-to-plane fitting to determine a spatial transformation for updating the 6-DOF odometry-related information of the vehicle.

The method, wherein the updating of the 6-DOF odometry-related information may comprise based on results of the point-to-line fitting and point-to-plane fitting, performing a nonlinear process to determine the spatial transformation.

The method, wherein the performing of the point-to-line fitting and point-to-plane fitting may comprise selecting a plurality of nearest neighbor points from among points within the point cloud data using a tree data structure, and based on the selected plurality of nearest neighbor points, determining a covariance matrix and performing QR decomposition process.

According to the present disclosure, a vehicle may comprise a sensor, a driving control circuit configured to control autonomous driving of the vehicle, a processor, and a memory storing at least one instruction that, when executed by the processor communicating with the memory, is configured to cause the vehicle to obtain, from the sensor, point cloud data associated with a surrounding environment of the vehicle, extract, from the point cloud data, a surface feature and an edge feature, wherein the surface feature and the edge feature represent static structures in the surrounding environment, determine, based on the extracted surface feature and the extracted edge feature, odometry information of the vehicle, update, based on spatial relationships within the point cloud data, the odometry information, generate, based on the updated odometry information, a map of the surrounding environment, output a signal indicating the map of the surrounding environment, and control, via the driving control circuit and based on the signal, autonomous driving of the vehicle.

The vehicle, wherein the at least one instruction, when executed by the processor communicating with the memory, is configured to cause the vehicle to identify, based on distances between points within the point cloud data, a group of neighboring points within the point cloud data, and based on the extracted surface feature, the extracted edge feature, and the identified group of neighboring points, determine the odometry information.

The vehicle, wherein the at least one instruction, when executed by the processor communicating with the memory, is configured to cause the vehicle to, using a three dimensional grid-based filtering process associated with updating of the odometry information, reduce a number of points in the point cloud data.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of the overall system for controlling a vehicle to automatically recognize an object and perform autonomous driving;

FIG. 2 shows an example of an algorithm for recognizing an object by means of an AI module and an autonomous driving sensor and calculating odometry;

FIG. 3 shows an example of a process of extracting a surface and edge feature-related point for each single frame;

FIG. 4A, FIG. 4B, and FIG. 4C show an example of a process of executing a 6-DOF odometry update;

FIG. 5 shows an example of executing a map accumulation management process according to an example of the present disclosure;

FIG. 6 shows an example to which an example of the present disclosure is applied;

FIG. 7 shows another example to which an example of the present disclosure is applied; and

FIG. 8 shows an example of a computing system for autonomous vehicle control and object recognition computation.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. Further, in describing the example of the present disclosure, a detailed description of well-known features or functions will be ruled out in order not to unnecessarily obscure the gist of the present disclosure.

In describing components of examples of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of sensor-based odometry, simultaneous localization and mapping of a surrounding environment of the vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.). One or more auxiliary devices (e.g., engine brake, exhaust brake, hydraulic retarder, electric retarder, regenerative brake, etc.) may also be controlled, for example, based on one or more features (e.g., features of sensor-based odometry, simultaneous localization and mapping of a surrounding environment of the vehicle) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of sensor-based odometry, simultaneous localization and mapping of a surrounding environment of the vehicle) described herein. Minimum risk maneuver (MRM) operation(s) may also be controlled, for example, based on one or more features (e.g., features of sensor-based odometry, simultaneous localization and mapping of a surrounding environment of the vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time. Biased driving operation(s) may also be controlled, for example, based on one or more features (e.g., features of sensor-based odometry, simultaneous localization and mapping of a surrounding environment of the vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc. One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of sensor-based odometry, simultaneous localization and mapping of a surrounding environment of the vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.). An autonomous driving level and/or autonomous driving activation/deactivation may also be controlled, for example, based on one or more features (e.g., features of sensor-based odometry, simultaneous localization and mapping of a surrounding environment of the vehicle) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

The present disclosure relates to techniques for enabling autonomous vehicles to estimate their position and map their surroundings in environments where positioning signals such as GPS may be unavailable or unreliable, such as indoor parking structures. An apparatus may utilize a light detection and ranging (LiDAR) sensor to collect three-dimensional point cloud data of the vehicle's surroundings. An artificial intelligence (AI) model may be used to process the data to identify edge and surface features—such as walls and pillars—and distinguishes between static and dynamic objects. Based on these features, the apparatus may estimate six degrees of freedom (6-DOF) odometry information, including the vehicle's spatial translation and rotation between time frames. The system further updates a surrounding environment map using the estimated odometry. By filtering out occlusion effects and moving object interference, the disclosed approach enhances the reliability of position estimation and supports real-time map generation in GPS-denied environments.

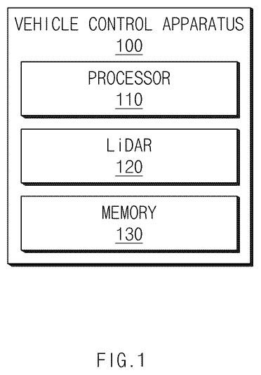

FIG. 1 shows an example of the overall system for controlling a vehicle to automatically recognize an object and perform autonomous driving according to an example of the present disclosure.

Referring to FIG. 1, a vehicle control apparatus 100 according to an example of the present disclosure may be implemented inside or outside a vehicle and some of the components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components (e.g., a GPS circuit, a vehicle communication interface, or a power management circuitry, etc.) which are not shown in FIG. 1.

The vehicle control apparatus 100 according to an example may include a processor 110, light detection and ranging (LiDAR) 120, and a memory 130. The processor 110, the LiDAR 120, and the memory 130 may be electronically or operably coupled with each other by an electronical component including a communication bus.

Hereinafter, that pieces of hardware are operably coupled with each other may include that a direct connection or an indirect connection between the pieces of hardware is established wired and/or wirelessly, such that second hardware is controlled by first hardware among the pieces of hardware.

The different blocks are illustrated, but an example is not limited thereto. For example, some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1.

The vehicle control apparatus 100 according to an example may include hardware for processing data based on one or more instructions. For example, the hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa-core, or an octa core (e.g., depending on the computational complexity of perception models, route planning, or control logic, etc.).

According to an example, the processor 110 may include at least one of a graphic processing unit (GPU) or a neural processing unit (NPU), or any combination thereof. For example, the GPU may be referred to as a visual processing unit (VPU). For example, the NPU may be referred to as a neural network processing unit (e.g., enhanced or optimized for running convolutional neural networks, transformer models, or sensor fusion algorithms, etc.).

The vehicle control apparatus 100 according to an example may include a depth sensor for detecting an external object. For example, the depth sensor for detecting the external object may include at least one of a time of flight (ToF) sensor, the LiDAR 120, a structured light sensor, an ultrasonic sensor, an infrared sensor, radio detection and ranging (RADAR), or an optical distance sensor, or any combination thereof (e.g., combining LiDAR and RADAR to improve robustness in low-visibility conditions, etc.). Hereinafter, a description will be given of LiDAR for convenience of description.

The vehicle control apparatus 100 according to an example may include the LiDAR 120 for obtaining a plurality of points based on a pulse laser signal. For example, the LiDAR 120 may obtain datasets for identifying a surrounding thing around the vehicle control apparatus 100 (or the vehicle including the vehicle control apparatus 100). For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding thing (e.g., a nearby vehicle, a pedestrian, a tree, or a building, etc.) to return.

For example, the LiDAR 120 may obtain datasets representing an external object in a space formed by an x-axis, a y-axis, and a z-axis, based on the pulse laser signal reflected from the surrounding thing. For example, the LiDAR 120 may obtain datasets including a plurality of points in the space formed by the x-axis, the y-axis, and the z-axis, based on receiving the pulse laser signal at a specified period (e.g., every 100 milliseconds, every sensor frame, or at a refresh rate of 10 Hz, etc.). For example, the plurality of points may include points representing the external object in a three-dimensional (3D) virtual coordinate system. The 3D virtual coordinate system may include at least one of a vehicle coordinate system or a LiDAR coordinate system, or any combination thereof. However, the example of the 3D virtual coordinate system is not limited to those described above (e.g., it may include a world coordinate system or a map-based coordinate system, etc.).

The memory 130 of the vehicle control apparatus 100 according to an example may include a hardware component for storing data and/or an instruction input and/or output from the processor 110 of the vehicle control apparatus 100. For example, the memory 130 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof (e.g., depending on cost, size, write endurance, or access speed, etc.).

One or more instructions indicating computation and/or an operation to be performed using data by the processor 110 of the vehicle control apparatus 100 may be stored in the memory 130 of the vehicle control apparatus 100. A set of the one or more instructions may be referred to as a program, firmware, an operating system, a process, a routine, a sub-routine, and/or an application (e.g., an object detector, a SLAM module, or a LiDAR segmentation engine, etc.).

Hereinafter, that the application is installed in the vehicle control apparatus 100 may mean that one or more instructions provided in the form of the application are stored in the memory 130, which may mean that the one or more applications are stored in a format executable by the processor 110 of the vehicle control apparatus 100 (e.g., as a file with an extension specified by the operating system of the vehicle control apparatus 100) (e.g., a binary executable file, or a compiled library, etc.).

For example, the memory 130 may include a first neural network model for detecting an object. For example, the memory 130 may include a second neural network model for outputting a type of the plurality of points obtained by the LiDAR 120 and/or a score of the plurality of points (e.g., object class scores or distance likelihoods, etc.).

In an example, the processor 110 may obtain at least one of a first virtual box for representing a target object or a first class indicating a type of the target object, or any combination thereof, based on the plurality of points obtained via the LiDAR 120 and the first neural network model stored in the memory 130.

In an example, the processor 110 may obtain at least one of the first virtual box for representing the target object or the first class indicating the type of the target object, or any combination thereof, based on inputting the plurality of points to the first neural network model. For example, the first neural network model may include an object detection model (e.g., a 3D bounding box detector or a center-based detection network, etc.). For example, the target object may include an external object located within a specified distance from the vehicle control apparatus 100 (or a host vehicle including the vehicle control apparatus 100) (e.g., within a 50-meter range in the forward direction, etc.). For example, the target object may include an object which is identified by the vehicle control apparatus 100 and is continuously tracked. For example, the type of the target object may include a plurality of types for classifying the target object. For example, the type of the target object may include at least one of a first type indicating the ground or a second type indicating a type different from the ground, or any combination thereof. However, the type of the target object is not limited to those described above. For example, the type of the target object may include, but is not limited to, at least one of a third type indicating a person or a fourth type indicating a vehicle, or any combination thereof (e.g., a bicycle, a traffic cone, a tunnel wall, or a construction sign, etc.).

In an example, the processor 110 may obtain at least one of first partial points corresponding to at least a portion of the target object among the plurality of points, based on the plurality of points and the second neural network model or a second class identified via the first partial points and indicating the type of the target object, or any combination thereof, based on the plurality of points and the second neural network model. For example, the second neural network model may include a segmentation model (e.g., a range-view CNN, a point-based classifier, or a sparse voxel network, etc.).

For example, the second neural network model may include a neural network model for obtaining the type of the plurality of points and the score of the plurality of points (e.g., softmax outputs, probability heatmaps, or class activation scores, etc.).

For example, the processor 110 may obtain the first partial points corresponding to the at least a portion of the target object among the plurality of points, based on inputting the plurality of points to the second neural network model. For example, the processor 110 may identify the type of the plurality of points, based on inputting the plurality of points to the second neural network model. For example, the processor 110 may obtain the first partial points corresponding to the at least a portion of the target object among the plurality of points, based on the type of each of the plurality of points (e.g., classifying some points as belonging to a vehicle, pedestrian, or roadside object, etc.).

According to an example, the processor 110 may perform a first specified algorithm for the plurality of points. For example, the processor 110 may perform the first specified algorithm for classifying the type of each of the plurality of points, for the plurality of points, for example, within the LiDAR data frame. For example, the processor 110 may classify second partial points corresponding to a specified type among the plurality of points. For example, the specified type may include a type representing the ground (e.g., pavement, crosswalks, or flat surfaces, etc.).

For example, the processor 110 may classify the second partial points corresponding to the specified type, based on performing the first specified algorithm for the plurality of points, and may exclude the second partial points from the plurality of points to obtain (or identify) the first partial points (e.g., separating above-ground structures from terrain, etc.).

In an example, the processor 110 may obtain at least one of a partial class for obtaining the second class, or the score of each of the plurality of points, or any combination thereof, based on inputting the plurality of points to the second neural network model. For example, the processor 110 may obtain the partial class and the score of each of the plurality of points, based on inputting the plurality of points to the second neural network model. For example, the partial class may include classifying each of the plurality of points as any type (e.g., tree, vehicle, pedestrian, or unknown, etc.).

For example, the processor 110 may fuse the partial class, the score of each of the plurality of points, and the second partial points (e.g., for joint feature enhancement or confidence weighting, etc.). For example, the processor 110 may perform clustering, based on fusing the partial class, the score of each of the plurality of points, and the second partial points. For example, the clustering may include grouping the first partial points corresponding to the at least a portion of the target object (e.g., to generate an instance-level region for bounding box generation, etc.).

For example, the processor 110 may obtain a point cloud for generating a second virtual box, based on the first partial points. For example, the processor 110 may obtain the point cloud, based on grouping the first partial points (e.g., using spatial proximity, density thresholding, or Density-Based Spatial Clustering of Applications with Noise (DBSCAN), etc.).

For example, the processor 110 may generate the second virtual box which is different from the first virtual box and is for representing the target object, based on the point cloud. For example, the second virtual box may include a box including at least some of the first partial points (e.g., tightly fitted to the object's spatial extent, etc.).

For example, the processor 110 may identify a heading direction indicating a progress direction of the target object, based on at least one of the first partial points or the point cloud, or any combination thereof (e.g., using temporal point shifts or bounding box orientation, etc.).

For example, the processor 110 may identify a position of the second virtual box on the virtual coordinate system, based on the at least one of the first partial points or the point cloud, or the any combination thereof (e.g., by computing the centroid of the clustered points, using a bounding box anchor, or referencing vehicle-relative coordinates, etc.). For example, the processor 110 may identify a size of the second virtual box, based on the at least one of the first partial points or the point cloud, or the any combination thereof. For example, the processor 110 may identify a second class, based on the at least one of the first partial points or the point cloud, or the any combination thereof (e.g., by estimating width, height, and depth based on point dispersion or statistical spread, etc.). For example, the processor 110 may identify at least one of the heading direction indicating the progress direction of the target object, the position of the second virtual box on the virtual coordinate system, the size of the second virtual box, or the second class, or any combination thereof (e.g., classifying as car, pedestrian, traffic cone, or unknown, etc.), based on the at least one of the first partial points or the point cloud, or the any combination thereof. For example, the processor 110 may identify a heading direction of a bounding box, based on at least one of the first virtual box, the first class, the heading direction of the second virtual box, the position of the second virtual box, the size of the second virtual box, or the second class, or any combination thereof (e.g., by tracking box orientation over time, using direction vectors, or aligning with lane markings, etc.). For example, the processor 110 may identify a position of the bounding box on the virtual coordinate system, based on the at least one of the first virtual box, the first class, the heading direction of the second virtual box, the position of the second virtual box, the size of the second virtual box, or the second class, or the any combination thereof (e.g., using Kalman filtering, relative coordinate mapping, or GPS reference data, etc.). For example, the processor 110 may obtain a third class indicating the type of the target object corresponding to the bounding box, based on the at least one of the first virtual box, the first class, the heading direction of the second virtual box, the position of the second virtual box, the size of the second virtual box, or the second class, or the any combination thereof (e.g., refining classification using fusion from multiple frames, object hierarchy rules, or semantic context, etc.). For example, the processor 110 may obtain at least one of the heading direction of the bounding box, the position of the bounding box on the virtual coordinate system, or the third class indicating the type of the target object corresponding to the bounding box, or any combination thereof, based on the at least one of the first virtual box, the first class, the heading direction of the second virtual box, the position of the second virtual box, the size of the second virtual box, or the second class, or the any combination thereof (e.g., for generating object tracks, scene graphs, or vehicle control cues, etc.).

For example, the processor 110 may assign a first identifier for tracking the second virtual box to the second virtual box (e.g., a unique ID based on timestamp, class, or location hash, etc.). For example, the processor 110 may assign a second identifier corresponding to the first identifier to the bounding box (e.g., to maintain identity consistency between detection and tracking outputs, etc.).

For example, the processor 110 may track the bounding box using the second identifier. For example, the processor 110 may track the target object, based on identifying a plurality of bounding boxes including the bounding box to which the second identifier is assigned, at a plurality of frames (e.g., through temporal association or object re-identification, etc.). For example, because the second identifier is an identifier assigned to the bounding box corresponding to the target object, the processor 110 may identify the plurality of bounding boxes to which the second identifier is assigned, at the plurality of frames (e.g., over multiple sensor cycles or time steps, etc.), to track the target object.

In an example, the processor 110 may output the bounding box corresponding to the target object, based on at least one of the first virtual box, the first class, the first partial points, or the second class, or any combination thereof (e.g., as a hexahedral 3D box, 2D projected box, or directional polygon, etc.). For example, the bounding box may include an example of representing the target object on the virtual coordinate system in the form of a hexahedron (e.g., defined by eight corner points in 3D space, etc.).

Hereinafter, a description will be given briefly of operations performed by the CPU, the GPU, and/or the NPU included in the processor 110.

According to an example, the processor 110 may include at least one of the CPU, the GPU, or the NPU, or any combination thereof. For example, at least one of the GPU or the NPU, or any combination thereof may obtain the first virtual box and the first class, based on the first neural network model (e.g., a region proposal network, transformer-based model, or YOLO-like detector, etc.). For example, at least one of the GPU or the NPU may obtain the first virtual box and the first class. For example, the at least one of the GPU or the NPU, or the any combination thereof may obtain the partial class for obtaining the second class and the score of each of the plurality of points, based on the second neural network model. For example, the at least one of the GPU or the NPU may obtain the partial class for obtaining the second class and the score of each of the plurality of points, based on the second neural network model (e.g., probability distributions over semantic labels, etc.). For example, the CPU may classify the second partial points corresponding to the specified type among the plurality of points, based on performing the first specified algorithm for classifying the type of each of the plurality of points, for the plurality of points (e.g., such as distinguishing ground, non-ground, or noise points, etc.).

As described above, the vehicle control apparatus 100 according to an example may include the at least one processor 110. The vehicle control apparatus 100 may detect the target object using the at least one processor 110 to accurately detect the target object. Furthermore, by performing a parallel process, the vehicle control apparatus 100 may reduce a load for each processor (e.g., enabling real-time LiDAR segmentation and object tracking, etc.).

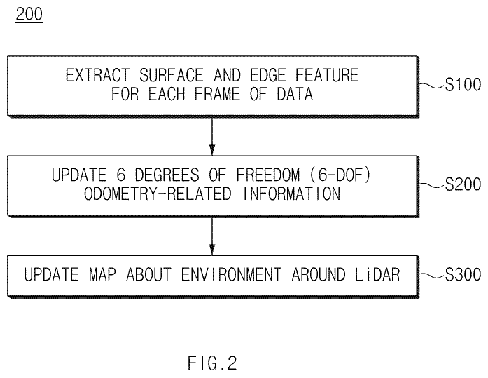

Meanwhile, before seeing FIG. 2, an object recognition-related description based on LiDAR is added for the overall understanding of AI object recognition according to the present disclosure as follows.

An object recognition process by the LiDAR 120 or the AI module passes through three steps, such as pre-processing, segmentation, and tracking. For example, AI module may include and execute one or more AI models (e.g., neural networks) for object recognition and segmentation in point cloud data (e.g., LiDAR point cloud data).

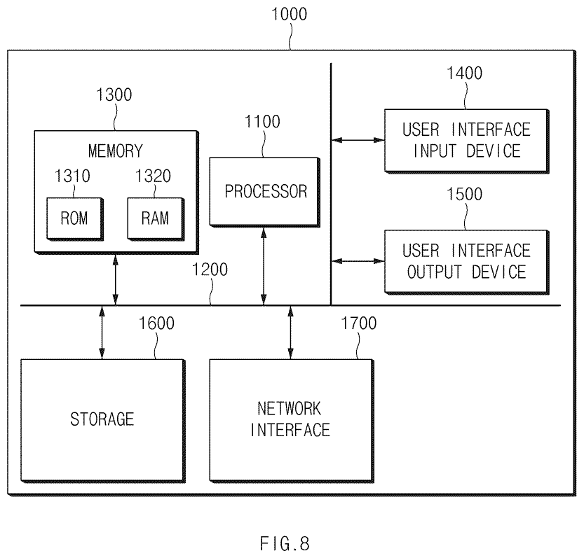

The object recognition system 1000 (refer to FIG. 8) according to the present disclosure may pass through pre-processing before executing an object recognition function. The pre-processing may include, for example, an operation of removing points forming the ground, based on laser sensing data (i.e., raw data) input from the LiDAR 120. Because it is able to be misrecognized as if there is any object on the ground by a laser beam reflected from the ground, so the process of separating the ground from a thing which is not the ground may be performed in the pre-processing step and may also be performed in the segmentation step if necessary.

For example, the pre-processing in AI object recognition is understood as a process in which an image processing tool of the AI module in the processor 110 removes noise of a LiDAR point cloud image, for example, reduces the total number of points which are present in the LiDAR point cloud image, for example, via a voxel downsampling technique, random sampling, range filtering, or grid-based clustering, etc., to promote computational efficiency.

For reference, the LiDAR point cloud image may be displayed in a bird's eye view (BEV) scheme. If a LiDAR map is generated as if it were a bird's eye view of the city while the bird flies in the sky, such map is referred to as a BEV image.

In other words, as described above, the LiDAR 120 transmits a laser beam to a surrounding environment and records a time when the laser beam is reflected from an object which is present in the outside to return, thus generating a point every many laser signals and calculating a distance to the point. By repeatedly transmitting many laser beams, the processor 110 may generate a real-time LiDAR map for the surrounding environment as a BEV type of 3D map (e.g., for parking assistance, collision avoidance, or lane detection, etc.) and may generate the real-time LiDAR map as a two-dimensional (2D) map in specific cases (e.g., flat terrain mapping or 2D occupancy grids, etc.).

The line or surface shown in black and white on the LiDAR point cloud map is actually composed of innumerable points (each of which is generated by the laser beam of the LiDAR 120). Due to this, a LiDAR sensing image is called a LIDAR point cloud image. Of course, for example, if a red, green, blue-depth (RGB-D) sensor and the LiDAR sensor are combined with each other, the LiDAR point cloud image may be re-implemented in color (e.g., to distinguish pedestrians, traffic cones, lane markings, or buildings, etc.).

If it is difficult for humans to recognize a thing using only one of many points in the LiDAR point cloud image, but, for example, if they synthetically look at the point cloud from the BEV's point of view or in the same way as a 2D floor plan, they may roughly guess whether the surrounding environment around the vehicle which is currently performing autonomous driving is any shape. In addition, for example, it is possible to recognize a vehicle, a bus, a pedestrian, a street tree, a traffic cone, a motorcycle, a traffic sign, or a bicycle, etc. which is present in the LiDAR point cloud image. Such a thing or person is called an object in an AI image recognition technology. It is possible to classify the object as a class which belongs to a group of the specific nature, such as a vehicle class, a bus class, a pedestrian class, or a tree class, etc.

The help of a deep AI neural network is required to classify whether any object in the LiDAR point cloud image is the vehicle class or the bus class. AI training (e.g., using labeled datasets, data augmentation, transfer learning, or synthetic simulation data, etc.) should precede to find objects in the LiDAR point cloud image via the AI neural network and identify a class of the object.

For example, a dataset called PANDASET™ includes more than 48,000 camera images (images captured primarily in the Silicon Valley region of the United States) and includes more than 16,000 LiDAR scam images. A total of 28 classes, such as pedestrians, cars, bicycles, construction site signs, and traffic signs, are arranged in the form of an annotation in these images.

Furthermore, the LiDAR point cloud image may be visualized to suit an option desired by the user using a point cloud working tool, such as Open3D™. Because the LiDAR 120 is able to detect a distance, it may more realistically reproduce a 3D LiDAR image in such a manner as to display a thing in a long distance in, for example, a deep blue and display a thing in a short distance in a light blue (e.g., for enhanced depth perception and visualization clarity, etc.), when the LiDAR point cloud image is visually processed using, for example, Open3D™.

In addition, as described above, the technology, for example, voxel (3D pixel) downsampling, may be applied to the LiDAR point cloud image to pre-process an original LiDAR image (i.e., raw data). Herein, the voxel refers to a 3D pixel in the shape of a regular hexahedron and the voxel downsampling is a technology for reducing the number of points not to require excessive computation (e.g., AI computational requirement to enable faster training or inference, or to match GPU memory constraints, etc.), even while maintaining a structure of various objects included in the LiDAR point cloud.

The LiDAR 120 radiates, for example, m laser beams n times during one scan cycle. In this case, the scan value of the laser beam which collides with an external object to return constitutes an (m×n) matrix. This (m×n) matrix data is called a range image. Each point constituting the LiDAR point cloud image may include depth (i.e., range) information and may further include intensity, an azimuth, an inclination, or the other additional information of the returned laser pulse (e.g., pulse width, timestamp, or number of returns, etc.). The range image is a large number of datasets, for example, Waymo™ open dataset (WOD). It is possible to perform AI learning of the range image.

A range view (RV) refers to a technique for converting a 3D point cloud into a 2D scene, for example, a 2.5D scene to represent the 3D point cloud as a 3D map that humans are able to intuitively understand, like an analog picture, rather than a large number of points. The 3D LiDAR point cloud image has 2D coordinates in the range view image, but the 3D laser-related information (e.g., the angle, the inclination, the intensity, and the like) which is recorded when previously obtaining the range image is not discarded (e.g., enabling the network to retain geometric fidelity despite dimensionality reduction, etc.). If a variable called a width is applied to (x, y) coordinates among (x, y, z) coordinate values of the 3D LiDAR image to obtain a coordinate on one axis in two dimensions and range image information indicating a range (depth) and a variable called a height are applied to the (z) coordinate to obtain a coordinate of the other axis in two dimensions, this is generated as a 2D range view image.

In addition, the AI algorithm according to the present disclosure may include a convolutional neural network (CNN). The CNN is an AI training module frequently used to extract a feature (or a feature point) from image data. To this end, there is a dataset composed of tens of thousands of commercially available images. The CNN currently has a version capable of processing each of one-dimensional to three-dimensional images (e.g., 1D signal processing, 2D camera images, or 3D volumetric data from LiDAR, etc.). In other words, the result of a range view image processing tool is learned by the CNN to perform a function of helping AI to accurately recognize an object in an image.

Because a thing present around an autonomous vehicle is finally recognized by a machine, the operation of generating a ground truth (GT) bounding box on the above-mentioned LiDAR map is also an important process in object recognition. Ground truth (GT) in machine learning is a term used when indicating an original value and a real value of data AI wants to learn. It may be usually viewed as a kind of image annotation overlaid on the LiDAR point cloud image as a bounding box with a box-shaped boundary (e.g., for identifying cars, pedestrians, bicycles, or lane markers, etc.).

In other words, the AI module fetches a label to group various objects to recognize the object (e.g., grouping motorcycles, traffic cones, delivery trucks, or traffic signs, etc.). Of course, an interval of 3D data points used to output a GT bounding box may be set, which may be set such that about 50 to 1000 LiDAR point cloud points are included in one GT bounding box.

Of course, there is no GT annotation in original data (or raw data) captured by the sensor, such as the LiDAR 120, while the vehicle is driving. The processor 110 should recognize a target which belongs to various classes, such as the road sign of the road, a crosswalk, a pedestrian, the other vehicle, and a center line, a curb, or a construction barrel, etc., as an object. The GT annotation is a means used to compare the result of determining the object recognized by the AI algorithm of the processor 110 with the reality to measure an error in object recognition and evaluate AI performance sometimes. A GT bounding box overlaid on the original image in the form of an annotation may be set manually by the user, but there is representatively a commercially available GT computation tool, such as grid-striding or polygon-based labeling interfaces, etc.

If the AI object recognition module is driven, a predicted bounding box may be checked. The result of being recognized as an object of a specific class by the processor 110 from the original image data obtained from the LiDAR 120 or the like is represented in the form of another bounding box similar to the GT bounding box. The predicted bounding boxes are the result of being calculated by an autonomous driving AI, which is different from the GT bounding box. The predicted bounding box may be identical to the GT bounding box, but may fail to be identical to the GT bounding box or may not at all have a region where the predicted bounding box and the GT bounding box overlap with each other (e.g., due to occlusion, sensor noise, incorrect class labeling, or bounding box misalignment, etc.).

For reference, because it is unable to conclude that an object of a specific class is actually present at a certain position definitely using only predicted bounding boxes, the predicted bounding boxes are usually called probability boxes (P-Boxes) or predicted bounding boxes.

Segmentation processing performed after the pre-processing refers to displaying a specific portion (e.g., traffic lights) of the road in, for example, red and displaying the rest (bituminous road) in blue (e.g., lane markings in yellow, sidewalks in green, or curbs in orange, etc.). Clustering the point cloud into a certain group and generating a P-Box may be performed in the segmentation step. For reference, there is a technology called cluster expansion. Herein, an expansion target may include a cluster up to a seed point and all points within an epsilon distance (the minimum distance constituting the cluster) (e.g., 0.5 m, 1 m, or 2 m depending on object density, etc.).

In other words, clustering based on the point cloud and P-Box generation proceeds upon the segmentation processing. For example, an AI network which performs segmentation is used to obtain a point label from the LiDAR 120 (e.g., to identify a tree, signpost, or parked car, etc.).

The present disclosure proposes a “rule-based” road surface recognition and label fusion technique to solve a ground surface recognition error problem which occurs upon segmentation. It is fine that any of various techniques, such as road surface recognition based on a slope, grid-based road surface recognition, and the other non-planar based road surface recognition (e.g., curvature-based, texture-based, or edge-detection-based techniques, etc.), is representatively applied to the road surface recognition algorithm. However, the present disclosure proposes adopting a slope-based road surface recognition technique, if recognizing a road surface in a tunnel (e.g., due to dim lighting, limited LiDAR returns, or flat tunnel geometry, etc.).

For reference, semantic segmentation is a task for attaching a unique class label to respective points in the point cloud generated by the LiDAR 120. The semantic segmentation in a LiDAR imaging technology is a technology for finding and using meaningful information from LiDAR data for object recognition or scene representation necessary to implement autonomous driving. There are already various semantic segmentation AI models, such as a projection-based method, a point-based method, and a sparse convolution-based method (e.g., Cylinder3D, RandLA-Net, or PointPillars, etc.). For example, the semantic segmentation result may be the AI computation result performed together with the NVIDIA DRIVE™ AGX system by the processor 110. Via such a configuration, various colors may be added to, for example, the LiDAR point cloud image.

The LiDAR image passes through the process called post-processing after the segmentation process. The post-processing refers to converting point cloud data into a 3D map or modeling, which is information meaningful for autonomous driving (e.g., for localization, path planning, or behavior prediction, etc.). A process of finally removing noise of the LiDAR point cloud image or an error in the LiDAR point cloud image, recognizing an object, such as a vehicle or a pedestrian, from the point cloud, and attaching and registering a unique identifier (e.g., object ID, timestamp, or class index, etc.) to the point cloud information if necessary is also included in the post-processing.

The LiDAR SLAM technology according to the present disclosure may basically operate according to the following algorithm. First of all, a sensor (i.e., the LiDAR 120) may execute a process of obtaining data. The obtained sensor data may be consistent data, noise of which is removed via the above-mentioned pre-processing process, which may be applied to an SLAM algorithm. Thereafter, the sensor data and surrounding images may be compared to execute approximate and primary positioning. Such a process is referred to as visual odometry (e.g., estimating the position of a vehicle, a drone, or a mobile robot, etc.). Furthermore, for example, a cluster associated with a 3D object may be constructed based on density of a point using a density-based spatial clustering of applications with noise (DBSCAN) clustering algorithm (e.g., for grouping points belonging to a car, a pedestrian, a traffic sign, or a tree, etc.). A 3D classification tool, such as POINTNET™, may be used.

Hereinafter, a description will be given of a core algorithm of the present disclosure with reference to FIG. 2. FIG. 2 shows an example of an algorithm 200 for recognizing an object by means of an AI module and an autonomous driving sensor and calculating odometry according to an example of the present disclosure (e.g., using a LiDAR-based sensor system, a camera-based system, or a radar-based sensor system, etc.).

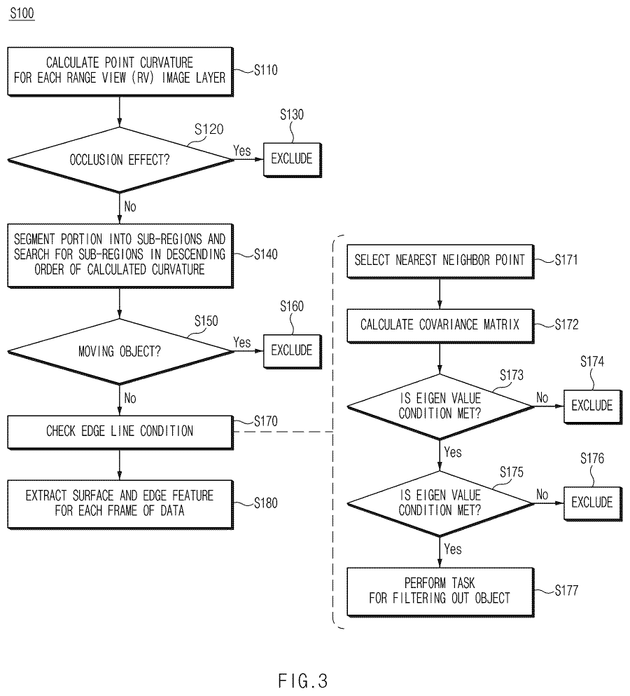

However, if necessary for convenience of description, FIGS. 3 to 7 are additionally referenced upon description about FIG. 2.

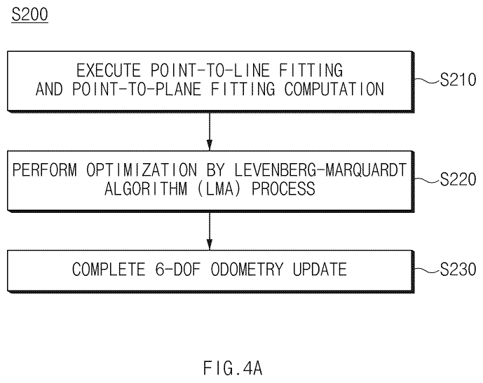

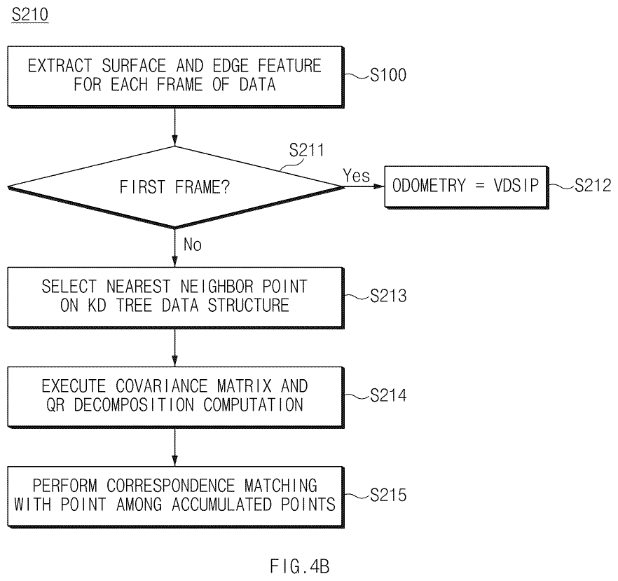

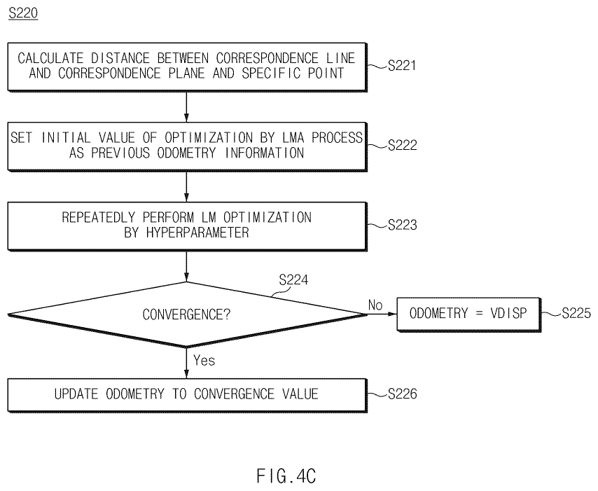

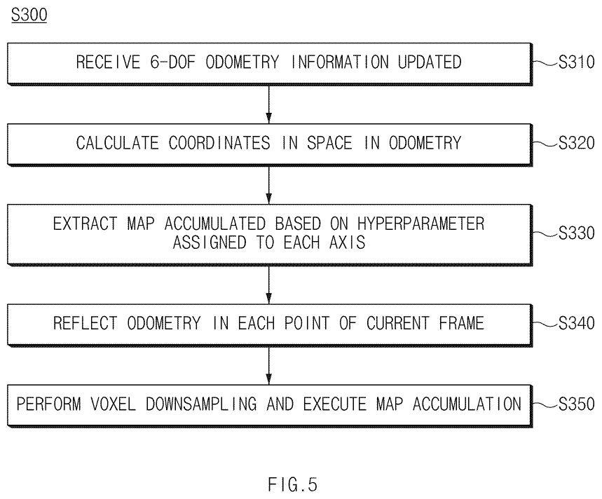

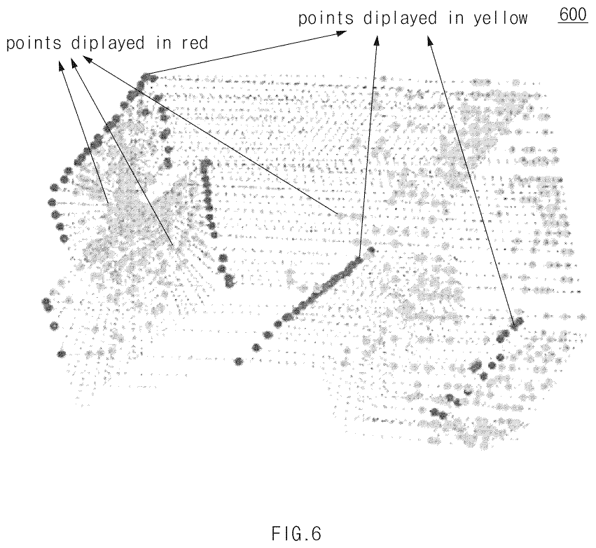

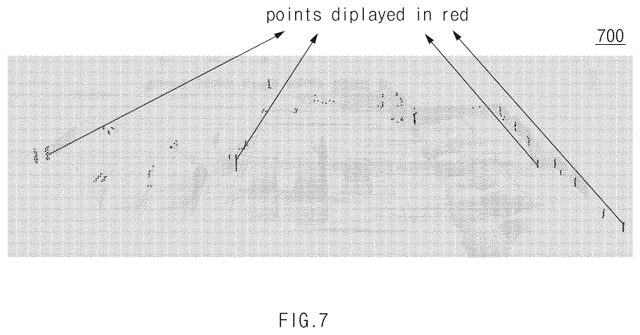

FIG. 3 shows an example of a process of extracting a surface and edge feature-related point for each single frame according to an example of the present disclosure (e.g., for every scan of LiDAR data, radar data, or structured-light sensor data, etc.). FIG. 4A, FIG. 4B, and FIG. 4C show an example of a process of executing a 6-DOF odometry update according to an example of the present disclosure (e.g., updating vehicle position, mobile robot pose, or UAV flight trajectory, etc.). FIG. 5 shows an example of executing a map accumulation management process according to an example of the present disclosure (e.g., integrating new sensor data into a map of a parking structure, tunnel, or warehouse, etc.). FIG. 6 shows an example to which an example of the present disclosure is applied (e.g., vehicle maneuvering in an indoor parking lot, etc.). FIG. 7 shows another example to which an example of the present disclosure is applied (e.g., vehicle navigation in a multi-level garage, etc.).

Referring to FIG. 2, in S100, a system (e.g., 1000, refer to FIG. 8) for recognizing an object by an AI module and an autonomous driving sensor and calculating odometry according to the present disclosure may extract a surface and edge feature for each frame of data (e.g., composed of a large number of points with three-dimensional (3D) coordinates such as from LiDAR scans, depth camera frames, or stereo images, etc.) which is input from the autonomous driving sensor, such as LiDAR 120.

As described above, the present disclosure is to overcome a limitation in positioning of a vehicle in an indoor parking lot situation. Because there is a limitation in which it is difficult to perform localization of a global navigation satellite system (GNSS) in positioning due to the nature of the indoor parking lot, the present disclosure aims to recognize a surrounding environment via the LiDAR 120 which is an external detection sensor, estimate motion of the vehicle, and simultaneously make a map about the surrounding environment (e.g., mapping pillars, ramps, parking slots, or entrances, etc.).

The present disclosure focuses on being advantageous to apply the above-mentioned SLAM technique, because the LiDAR 120 is able to detect a time when a laser beam is reflected to return and calculate a distance between a sensor and a wall (e.g., a pillar, a wall surface, or a parked vehicle, etc.) in a 3D space.

Next, in S200, the system may update 6 degrees of freedom (6-DOF) odometry-related information based on the surface and edge feature extracted in S100 (e.g., updating the vehicle's position and orientation as it drives, parks, or maneuvers in tight indoor spaces, etc.).

6-DOF in the present disclosure refers to, for example, an algorithm for predicting sensor motion between adjacent image frames in point cloud image data received in real time from the LiDAR 120 and calculating a rotation and translation transformation matrix (e.g., tracking movement along X, Y, Z axes and rotation about roll, pitch, and yaw, etc.).

The above odometry calculation technique is used to estimate motion in a space of an ego-vehicle via a “correspondence matching” and optimization process between features in consecutive image frames in extracting a feature from sensor data (particularly, point cloud data), localizing the ego-vehicle based on the extracted feature, and generating an environment map (e.g., for path planning, collision avoidance, or real-time localization, etc.).

In S300, the system may update a map about an environment around the LiDAR 120 based on the updated odometry. In the present disclosure, this will be defined as “accumulation”. In other words, estimating short-term motion (i.e., odometry) of the ego-vehicle between time point t−1 and time point t and inversely feeding back and accumulating the estimated result to an edge feature point obtained at time point t−1 on the basis of time point t (i.e., a current time point) is “accumulation” (e.g., updating a map with newly detected obstacles, refining parking boundaries, or integrating recent trajectory data, etc.).

FIG. 3 illustrates in detail S100. Referring to FIG. 3, in S110, the system may calculate point curvature for each range view (RV) image layer for the point cloud data input from the LiDAR 120 (e.g., processing layers corresponding to different vertical angles, scan rings, or sensor channels, etc.).

In S120, the system may determine whether there is an occlusion effect which is an edge case of LiDAR measurement in the image (e.g., caused by another vehicle, a pillar, or a pedestrian blocking the sensor, etc.). If so, the system may move to S130 to exclude it from subsequent computation according to the present disclosure. Upon a negative determination (e.g., NO) in S120, the system may move to S140 to segment a portion where there is no occlusion effect in the RV image into sub-regions and may sort and search for the sub-regions in descending order of the calculated curvature (e.g., processing the most sharply curved regions first, such as corners, curb edges, or sharp turns, etc.).

In S150, the system may determine whether a class of an object to be analyzed is a moving object (e.g., identifying if the detected object is a person, a cyclist, or a moving vehicle, etc.). In other words, determining whether object class classification information from the point cloud is a computation exclusion target is S150. The computation exclusion target is representatively a moving object, such as a pedestrian, a bicycle, or a vehicle. The moving object may receive an affirmative determination (e.g., YES) in S150 and may be excluded from computation according to the present disclosure in S160.

In S170, the system may check an edge line condition for a static object (e.g., determining if the feature represents a building corner, a wall edge, or a parking lot barrier, etc.). In S180, the system may complete S100.

Referring continuously to FIG. 3, in S170, the system may subdivide S170. In S171, the system may select a plurality of nearest neighbor points. In S172, the system may calculate a covariance matrix. In S171, the system may select, for example, 10 nearest neighbor points via a k-dimensional tree data structure (e.g., a data structure used to efficiently organize points in a multi-dimensional space, primarily for nearest neighbor searches). A distance between points, which is a criterion, is based on an L2 norm distance (i.e., a Euclidean distance).

Next, in S173, the system may determine whether an eigen value condition for a straight line object determination is met (e.g., if the principal eigenvalue is much larger than the other eigenvalues, indicating a linear arrangement, etc.). If it is determined that it is not a straight line, the system may move to S174 to end the present computation.

In other words, in S173, the system may perform a process in such a manner as to determine that it has the tendency of a line segment, if the largest eigen value is a certain multiple greater than the next largest eigenvalue based on the covariance matrix (e.g., a threshold ratio of 10:1 or higher, etc.).

If not, the system may move to S175 to determine a cosine similarity condition for determining an object with a vertical component (e.g., checking if the principal direction is nearly aligned with the Z-axis, etc.). If it is not the vertical component, the system may move to S176, and the system may end the present computation. In S175, the system may calculate a cosine similarity between an eigen vector corresponding to the largest eigen value and a surface vector.

As a result, in S177, the system may perform a task for filtering out an object with a “vertical component”, which is a “linear type” of object (e.g., a pillar, a column, or a light pole, etc.). Representatively, pillars in the indoor parking lot may be objects capable of passing through determination to S177.

FIG. 4A subdivides S200 of the present disclosure shown in FIG. 2. Referring to FIG. 4A, first of all, in S210, the system may execute point-to-line fitting and point-to-plane fitting operations based on the extracted surface and edge feature (e.g., aligning detected edge points to wall boundaries, surface points to floor planes, or mapping feature points to known parking lot structures, etc.).

Next, in S220, the system may perform a nonlinear process, such as a Levenberg-Marquardt algorithm (LMA) process based on the result of the point-to-line fitting and point-to-plane fitting operations (e.g., iteratively refining the estimated vehicle pose, optimizing alignment for a mobile robot, or minimizing fitting error for a drone, etc.).

In S230, the system may finally end S200 to complete the 6-DOF odometry update (e.g., updating the pose estimate for use in mapping, navigation, or localization, etc.).

A description will be given in detail of S210 in FIG. 4B.

In other words, if the surface and edge feature point is extracted for each single frame in S100, in S211 shown in FIG. 4B, the system may determine whether a corresponding frame is a first frame. Upon determination that the corresponding frame is the first frame in S211, the system may receive an affirmative determination to move to S212. In this case, the odometry may be updated to VDISP which is a quaternion, such as yaw, pitch, and roll (e.g., setting the initial orientation for a newly started navigation session, etc.).

Upon a negative determination in S211, the system may move to S213 to select a plurality of nearest neighbor points using the k-dimensional tree data structure (e.g., finding the closest 10 points in 3D space to each feature point, etc.) upon the point-to-line fitting and point-to-plane fitting operations. In S214, the system may execute covariance matrix and QR decomposition operations for the selected nearest neighbor points (e.g., using covariance to characterize spatial distribution and QR decomposition for geometric analysis, etc.).

Thereafter, in S215, the system may perform correspondence matching with the point among points accumulated in a map of the surrounding environment (e.g., matching new edge features to previously mapped wall edges, etc.). In other words, it is understood that the covariance matrix is to determine a correspondence line and QR decomposition of the matrix is to determine a correspondence plane (e.g., using eigenvalues to detect linear features and QR decomposition to identify planar surfaces, etc.).

A description will be given in detail of S220 according to the present disclosure in FIG. 4C.

In other words, in S221, the system may calculate a distance between the correspondence line and the correspondence plane and a specific point (e.g., measuring how closely a detected edge aligns with a wall, etc.). In S222, the system may set an initial value of the optimization by the above-mentioned LMA process as previous odometry information (e.g., using the last known vehicle pose as a starting point, etc.).

In S223, the system may repeatedly perform the nonlinear process, such as the LM optimization by a hyperparameter n used in machine learning. A Levenberg-Marquardt (LM) method is actually the more representative method for addressing a nonlinear least squares problem (e.g., minimizing fitting error for path estimation, correcting trajectory drift, or refining scan alignment, etc.). In addition, there are various function optimization techniques, such as a Newton-Raphson method and a Gauss-Newton method. However, the present disclosure proposes a method for adopting the LM technique.

In S224, the system may determine whether there is convergence. If there is no convergence, the system may move to S225 to perform substantially the same operation as S212 (e.g., reinitializing the process with different parameters, etc.). If there is the convergence, the system may move to S226 to update the odometry to the convergence value (e.g., storing the new pose estimate for use in subsequent mapping, etc.).

FIG. 5 subdivides S300 of FIG. 2.

In other words, in S310, the system may receive the 6-DOF odometry information updated in S200. In S320, the system may calculate coordinates in space (e.g., 3D coordinates) in the odometry (e.g., determining the current X, Y, Z location of the vehicle, etc.). In S330, the system may extract a map of the surrounding environment, accumulated based on a hyperparameter assigned to each axis on the coordinates in space (i.e., an individual hyperparameter for each of an x-axis, a y-axis, and a z-axis) (e.g., using separate thresholds for map resolution along each axis, etc.). In S340, the system may reflect the odometry in each point of a current frame at time point t (e.g., transforming new sensor data into the global map frame, etc.). In S350, as described above, the system may perform voxel downsampling based on voxel grid filtering for the result of the odometry and may execute map accumulation (e.g., reducing redundant points, keeping only one point per voxel grid cell, and merging them into the existing map, etc.).

Now, seeing a first example 600 of FIG. 6, edge and surface feature points per single frame are illustrated in FIG. 6. In other words, red points indicate surface feature points recognized according to the present disclosure and yellow points indicate edge feature points recognized according to the present disclosure (e.g., surface points representing floor areas, edge points representing curbs or barriers, etc.). It is able to be checked in FIG. 6 that a surface and an edge (e.g., a pillar of an underground parking lot) is clearly discriminated even in an underground parking lot situation (e.g., distinguishing structural columns from flat wall surfaces, etc.).

In a second example 700 of FIG. 7, the result of accumulating edge feature points by 11 frames using 6-DOF odometry estimation is illustrated (e.g., integrating feature data from multiple sensor sweeps as a vehicle moves, etc.). Points displayed in red indicate objects, each of which has a vertical component (e.g., pillars, columns, or vertical posts, etc.).

FIG. 8 shows an example of a computing system 1000 for autonomous vehicle control and object recognition computation according to an example of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media (e.g., flash memory, solid-state drives (SSDs), magnetic disks, or phase-change memory, etc.). For example, the memory 1300 may include a read only memory (ROM) 1310 and a random access memory (RAM) 1320 (e.g., DRAM, SRAM, or LPDDR, etc.).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an EPROM, an EEPROM, a register, a hard disc, a removable disk, and a CD-ROM (e.g., SSD, USB drive, or optical media).

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal (e.g., an onboard vehicle controller or mobile computing platform). In another case, the processor and the storage medium may reside in the user terminal as separate components.

According to an example of the present disclosure, a system for recognizing an object by means of an AI module and an autonomous driving sensor and calculating odometry may include a processor loaded with an object recognition module for recognizing an object which is present in a surrounding environment as a point cloud from data input from the autonomous driving sensor as a part of the AI module and a memory storing data about the point cloud. The AI module may execute a first step of extracting a surface and edge feature for each frame of data input from the autonomous driving sensor, a second step of updating 6 degrees of freedom (6-DOF) odometry-related information based on the extracted surface and edge feature, and a third step of updating a map about the surrounding environment based on the updated odometry.

In the system for calculating the odometry based on the AI and the autonomous driving sensor according to another example of the present disclosure, the first step may include calculating point curvature for each range view (RV) image layer for the input data, dividing a portion where there is no occlusion effect as an RV image into sub-regions, sorting the sub-regions in descending order of the calculated curvature, and determining whether object class classification information from the point cloud is a computation exclusion target, and checking an edge line condition, if it is determined that the object class classification information is not the computation exclusion target.

In the system for calculating the odometry based on the AI and the autonomous driving sensor according to another example of the present disclosure, the checking of the edge line condition may include selecting a nearest neighbor point, calculating a covariance matrix, and determining an eigen value condition for determining a straight line object and a cosine similarity condition for determining an object with a vertical component.

In the system for calculating the odometry based on the AI and the autonomous driving sensor according to another example of the present disclosure, the nearest neighbor point may be selected by N based on an L2 norm distance on a k-dimensional tree data structure.

In the system for calculating the odometry based on the AI and the autonomous driving sensor according to another example of the present disclosure, the second step may include executing point-to-line fitting and point-to-plane fitting computation based on the extracted surface and edge feature.

In the system for calculating the odometry based on the AI and the autonomous driving sensor according to another example of the present disclosure, the second step may include performing optimization by a Levenberg-Marquardt algorithm (LMA) process based on the result of the point-to-line fitting and point-to-plane fitting computation.

In the system for calculating the odometry based on the AI and the autonomous driving sensor according to another example of the present disclosure, the executing of the point-to-line fitting and point-to-plane fitting computation may include selecting a nearest neighbor point using a k-dimensional tree data structure and executing covariance matrix and QR decomposition computation for the nearest neighbor point.

In the system for calculating the odometry based on the AI and the autonomous driving sensor according to another example of the present disclosure, the executing of the point-to-line fitting and point-to-plane fitting computation may include searching for a correspondence line or plane among accumulated points.

In the system for calculating the odometry based on the AI and the autonomous driving sensor according to another example of the present disclosure, an initial value of the optimization by the LMA process may be set as previous odometry information.

In the system for calculating the odometry based on the AI and the autonomous driving sensor according to another example of the present disclosure, the third step may include calculating coordinates in space in the odometry, extracting a map accumulated based on a hyperparameter assigned to each axis of the coordinates in space, reflecting the odometry in each point of a current frame, and performing voxel downsampling based on voxel grid filtering for the reflected odometry result and executing map accumulation.

According to another example of the present disclosure, a method for recognizing an object by means of an AI module and an autonomous driving sensor and calculating odometry may include the AI module executing a first step of extracting a surface and edge feature for each frame of data input from the autonomous driving sensor, a second step of updating 6 degrees of freedom (6-DOF) odometry-related information based on the extracted surface and edge feature, and a third step of updating a map about a surrounding environment based on the updated odometry.

The present disclosure may enable simultaneous localization and mapping (SLAM) and positioning based on a feature in a situation in which it is difficult to perform positioning or transmit and receive a wireless signal for mapping around an autonomous vehicle, such as an indoor parking lot (e.g., a tunnel, a warehouse, or a multi-level garage, etc.), thus calculating 6 degrees of freedom (6-DOF) odometry with high reliability using data of an autonomous driving sensor, such as a LiDAR sensor (e.g., a 3D LiDAR, a stereo camera, or a radar sensor, etc.).

For example, the present disclosure may extract features about a robust edge (e.g., an edge of a pillar) and a plane, particularly, a surface in a single frame depending on determination of curvature defined based on distance information (e.g., sharpness of a corner, flatness of the floor, or steepness of a ramp, etc.) and may estimate 6-DOF odometry with high reliability via a nonlinear optimization countermeasure via a correspondence matching process (e.g., matching detected features between consecutive frames to estimate movement, etc.).

Of course, it is possible to make a map in real time even in an indoor parking lot based on the estimated odometry (e.g., updating a map as a vehicle drives, creating a floor plan, or visualizing parking slot positions, etc.). The present disclosure may select a feature point advantageous to reflect an indoor parking lot characteristic to estimate odometry, thus estimating and calculating more robust 6-DOF odometry and simultaneously managing a map in real time (e.g., prioritizing pillar edges, wall surfaces, or painted boundaries as feature points, etc.).

In addition, the present disclosure may overcome an occlusion effect which is an edge case according to relative distance information of LiDAR sensor data (e.g., when a moving vehicle blocks part of the sensor's field of view, etc.) and may remove a moving object point which interferes with odometry estimation using the AI inference result of a point cloud segmentation network (e.g., filtering out pedestrians, bicycles, or shopping carts, etc.), thus estimating odometry with higher reliability than an existing technology based on so-called LiDAR odometry and mapping (LOAM) based on only curvature determination.

In addition, those skilled in the air may understand various effects other than the effects described above from the present disclosure, via the detailed description of the present disclosure and the accompanying drawings.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus of a vehicle, the apparatus comprising:
a processor; and
a memory storing at least one instruction that, when executed by the processor communicating with the memory, is configured to cause the apparatus to:
obtain, from a sensor of the vehicle, point cloud data associated with at least one object in a surrounding environment of the vehicle,
extract, based on an artificial intelligence model of the vehicle, a surface and edge feature for each frame of the point cloud data,
based on the extracted surface and edge feature, update 6 degrees of freedom (6-DOF) odometry-related information of the vehicle,
based on the updated 6-DOF odometry-related information, update a map of the surrounding environment of the vehicle,
output a signal indicating the updated map, and
control, based on the signal, autonomous driving of the vehicle.

2. The apparatus of claim 1, wherein the at least one instruction that, when executed by the processor communicating with the memory, is configured to cause the apparatus to extract the surface and edge feature by:
calculating point curvature for each range view (RV) image layer for the point cloud data;
dividing, as an RV image layer, a portion of the point cloud data that has no occlusion effect into sub-regions;
sorting the sub-regions in descending order of the calculated point curvature;
determining, for each of the sub-regions, whether object class classification information from the point cloud data indicates that the sub-region should be excluded from the surface and edge feature extraction; and
based on the sub-region not being excluded, determining whether the sub-region satisfies an edge line condition, wherein the edge line condition corresponds to a condition indicating a presence of a linear edge.

3. The apparatus of claim 2, wherein the determining of whether the sub-region satisfies the edge line condition comprises:
selecting a plurality of nearest neighbor points from among a plurality of points within the sub-region;
determining, based on the plurality of selected nearest neighbor points, a covariance matrix;
determining whether an eigen value condition associated with the covariance matrix is satisfied to indicate a straight line object; and
determining whether a cosine similarity condition associated with the covariance matrix is satisfied to indicate an object with a vertical component.

4. The apparatus of claim 3, wherein the plurality of nearest neighbor points are selected, using a tree data structure, based on an L2 norm distance between points within the point cloud data.

5. The apparatus of claim 1, wherein the at least one instruction that, when executed by the processor communicating with the memory, is configured to cause the apparatus to update the 6-DOF odometry-related information of the vehicle by:
performing, based on the extracted surface and edge feature, point-to-line fitting and point-to-plane fitting to determine a spatial transformation for updating the 6-DOF odometry-related information of the vehicle.

6. The apparatus of claim 5, wherein the at least one instruction that, when executed by the processor communicating with the memory, is configured to cause the apparatus to update the 6-DOF odometry-related information of the vehicle by:
based on results of the point-to-line fitting and point-to-plane fitting, performing a nonlinear process to determine the spatial transformation.

7. The apparatus of claim 5, wherein the performing of the point-to-line fitting and point-to-plane fitting comprises:
selecting a plurality of nearest neighbor points from among points within the point cloud data using a tree data structure; and
based on the selected plurality of nearest neighbor points, determining a covariance matrix and performing a QR decomposition process.

8. The apparatus of claim 5, wherein the performing of the point-to-line fitting and point-to-plane fitting comprises:
searching for a correspondence line or plane among points accumulated in the map of the surrounding environment of the vehicle.

9. The apparatus of claim 6, wherein an initial value of the nonlinear process is set based on previous odometry information.

10. The apparatus of claim 1, wherein the at least one instruction that, when executed by the processor communicating with the memory, is configured to cause the apparatus to update the map of the surrounding environment of the vehicle by:
determining, based on the updated 6-DOF odometry-related information, coordinates in space for the vehicle;
extracting, from the map of the surrounding environment, based on a hyperparameter assigned to each axis of the coordinates in space, data accumulated for updating the map of the surrounding environment;
applying the updated 6-DOF odometry-related information to a current frame of the point cloud data; and
performing voxel downsampling based on voxel grid filtering for the current frame of the point cloud data to which the updated 6-DOF odometry-related information is applied, and accumulating resulting points of the voxel downsampling for updating the map of the surrounding environment.

11. A method performed by an apparatus of a vehicle, the method comprising:
obtaining, from a sensor of the vehicle, point cloud data associated with at least one object in a surrounding environment of the vehicle;
extracting, based on an artificial intelligence model of the vehicle, a surface and edge feature for each frame of the point cloud data;
based on the extracted surface and edge feature, updating 6 degrees of freedom (6-DOF) odometry-related information of the vehicle;
based on the updated 6-DOF odometry-related information,
updating a map of the surrounding environment of the vehicle;
outputting a signal indicating the updated map; and
controlling, based on the signal, autonomous driving of the vehicle.

12. The method of claim 11, wherein the extracting of the surface and edge feature comprises:
calculating point curvature for each range view (RV) image layer for the point cloud data;
dividing, an RV image layer, a portion of the point cloud data that has no occlusion effect into sub-regions;
sorting the sub-regions in descending order of the calculated point curvature;
determining, for each of the sub-regions, whether object class classification information from the point cloud data indicates that the sub-region should be excluded from the surface and edge feature extraction; and
based on the sub-region not being excluded, determining whether the sub-region satisfies an edge line condition, wherein the edge line condition corresponds to a condition indicating a presence of a linear edge.

13. The method of claim 12, wherein the determining of whether the sub-region satisfies the edge line condition comprises:
selecting a plurality of nearest neighbor points from among a plurality of points within the sub-region;
determining, based on the plurality of selected nearest neighbor points, a covariance matrix;
determining whether an eigen value condition associated with the covariance matrix is satisfied to indicate a straight line object; and
determining whether a cosine similarity condition associated with the covariance matrix is satisfied to indicate an object with a vertical component.

14. The method of claim 13, wherein the plurality of nearest neighbor points are selected, using a tree data structure, based on an L2 norm distance between points within the point cloud data.

15. The method of claim 11, wherein the updating of the 6-DOF odometry-related information comprises:
performing, based on the extracted surface and edge feature, point-to-line fitting and point-to-plane fitting to determine a spatial transformation for updating the 6-DOF odometry-related information of the vehicle.

16. The method of claim 15, wherein the updating of the 6-DOF odometry-related information comprises:
based on results of the point-to-line fitting and point-to-plane fitting, performing a nonlinear process to determine the spatial transformation.

17. The method of claim 15, wherein the performing of the point-to-line fitting and point-to-plane fitting comprises:
selecting a plurality of nearest neighbor points from among points within the point cloud data using a tree data structure; and
based on the selected plurality of nearest neighbor points, determining a covariance matrix and performing QR decomposition process.

18. A vehicle comprising:
a sensor;
a driving control circuit configured to control autonomous driving of the vehicle;
a processor; and
a memory storing at least one instruction that, when executed by the processor communicating with the memory, is configured to cause the vehicle to:
obtain, from the sensor, point cloud data associated with a surrounding environment of the vehicle,
extract, from the point cloud data, a surface feature and an edge feature, wherein the surface feature and the edge feature represent static structures in the surrounding environment,
determine, based on the extracted surface feature and the extracted edge feature, odometry information of the vehicle,
update, based on spatial relationships within the point cloud data, the odometry information,
generate, based on the updated odometry information, a map of the surrounding environment,
output a signal indicating the map of the surrounding environment, and
control, via the driving control circuit and based on the signal, autonomous driving of the vehicle.

19. The vehicle of claim 18, wherein the at least one instruction, when executed by the processor communicating with the memory, is configured to cause the vehicle to:
identify, based on distances between points within the point cloud data, a group of neighboring points within the point cloud data, and
based on the extracted surface feature, the extracted edge feature, and the identified group of neighboring points, determine the odometry information.

20. The vehicle of claim 18, wherein the at least one instruction, when executed by the processor communicating with the memory, is configured to cause the vehicle to, using a three dimensional grid-based filtering process associated with updating of the odometry information, reduce a number of points in the point cloud data.
